(19) United States
(12) Patent Application Publication
(10) Pub. No.: US 2009/0213531 A1
(43) Pub. Date: Aug. 27, 2009

(54) Transformer substation

(76) Inventor: Arne Berggren, Vasteras (SE)

Correspondence Address: VENABLE LLP, P.O. BOX 34385, WASHINGTON, DC, 20043-9998, US

(21) Appl. No.: 11/667,117

(22) PCT Filed: Nov. 7, 2005
(86) PCT No.: PCT/SE05/01675

§ 371 Date: Mar. 17, 2009

(30) Foreign Application Priority Data
Nov. 5, 2004 (SE) 0402751-2

(51) Int. Cl. H02B 7/00

(52) U.S. Cl. 361/603

(57) ABSTRACT

A transformer substation including a transformer, switching equipment and switchgear equipment arranged in closed rooms.

### TECHNICAL FIELD

The present invention relates to a transformer substation for medium voltage. Such a substation comprises a transformer, a first switchgear unit and a second switchgear unit. The invention especially relates to an indoor substation. The meaning of medium voltage (MV) is different among the countries of the world. A common interpretation of medium voltage is within the range of 1 kV to 72 kV.

### BACKGROUND ART

A substation for medium voltage is usually placed outdoors and requires considerable ground space. The substation is constructed on site, which involves the presence of several persons who have to work under sometimes harsh conditions and in certain cases far from any built-up area. The on-site construction also involves complicated transport work of parts that are to be assembled. If a substation needs to be moved due to the fact that the power requirement terminates, this involves demolition of buildings and foundations at a first location and new construction and new installation of switchgear and controlgear at a different location.

According to U.S. Pat. No. 6,195,253 (Fahlgren et al), a substation is previously known, according to which the present problems are partially solved. Thus, the known station exhibits an enclosure not only of the two switchgear units but also an enclosure of the transformer. By this construction, a closed building is obtained which may be carried out with less space requirement than prior art solutions.

Still the station must be built up and connected at the construction site. Thus, there is a need of a substation that not only offers an efficient utilization of space but also a more efficient construction. There is also a need to be able to move the station in a simple manner and to rapidly assemble it at some other location with a minimum impact on the environment and with minimum work effort.

### SUMMARY OF THE INVENTION

The object of the invention is to seek ways of providing an improved substation.

The above objects are achieved according to the invention by a substation according to the features described in the characterizing portion of the independent claim 1, and with a method according to the features described in the characterizing portion of the independent claim 9. Advantageous embodiments are described in the characterizing portions of the dependent claims.

According to the invention, the substation comprises a plurality of modules which are manufactured under industrial forms at a factory. The modules are transported to the site of erection where they are erected and joined together into a finished substation within a few days. At the same time as the switchgear modules are manufactured indoors, ground operations are carried out at the construction site so that the ground operations are completed when the modules arrive. The system comprises a plurality of switchgear modules comprising switching equipment and switchgear equipment as well as a base module housing the transformer. The switchgear modules are connected to the base module and form side walls for the base module.

The base module comprises a factory-made transformer base and a frame structure for supporting a roof module. The base is suitably made of concrete and the frame structure of steel. The base module is placed on the smoothed ground and the transformer is placed on the base. The frame structure, which comprises a plurality of columns, is mounted on the base and the roof module is attached to the frame structure. The factory-made switchgear modules are placed adjacent the base module so as to adjoin the base module. In this way, the adjoining outer sides of the switchgear modules form inner walls in the base module. In an advantageous embodiment of the invention, the switchgear modules are brought to be attached to the base module so that they are suspended from the base module. In this way, the ground work is further reduced in that the ground surface below the base module only has to be processed and smoothed.

The modular construction and the industrial manufacture enable the modules to be connected together and tested prior to delivery. When moving the whole station to another site, the modules of the station are disconnected and transported to the new site of erection that has been prepared according to the above. No new buildings or base plates are required and no demolition of buildings and/or base plates is required.

In an advantageous embodiment, the whole substation is placed on a mobile platform. By such a mobile embodiment of the invention, a complete substation is transported to the site of an existing station. The mobile substation is connected in parallel with the existing one so that the latter may be disconnected. This permits maintenance and repair work on the existing station to be carried out in a simple manner. A mobile platform comprises a base plate that supports the substation and that comprises a wheel arrangement or a float for transport. Such a platform is suitably connected to a traction vehicle. In a further embodiment, the mobile platform comprises a drive source and control device of its own in order to move the mobile substation of its own accord.

From a first aspect, the invention comprises a substation comprising a base module that includes a transformer and a plurality of switchgear modules which are mounted to the base module so that these form walls for the base module.

From a second aspect, the invention comprises a method for manufacturing a substation. In this way, switchgear modules and the base plate for the base module are manufactured while at the same time the ground work is in progress. Thereafter, the modules are transported to the site where they are assembled into a completed substation in a few days' time.

### BRIEF DESCRIPTION OF THE DRAWINGS

The invention will be explained in greater detail, by description of an embodiment, with reference to the accompanying drawings, wherein:

FIG. 1 is a section of a complete substation according to the invention, and

FIG. 2 is a plan view of the substation.

### DESCRIPTION OF THE PREFERRED EMBODIMENTS

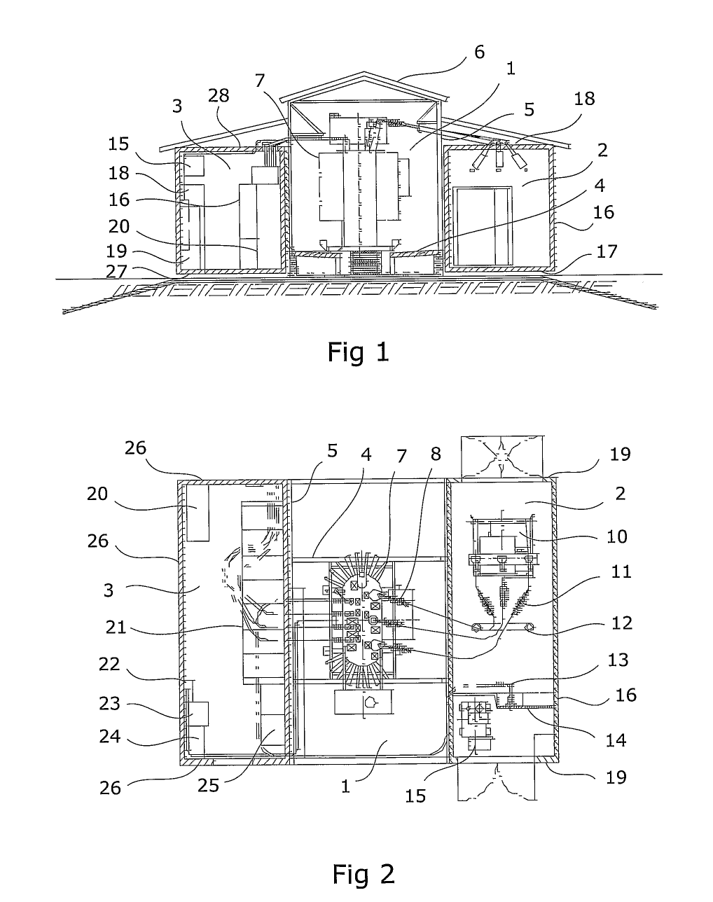

An embodiment of a substation according to the invention is shown in FIG. 1. The substation comprises a base module 1, a first switchgear module 2 and a second switchgear module 3. The base module accommodates a transformer 7 and comprises a base plate 4 that supports the transformer, a roof module 6 and a frame structure 5 that supports the roof module. The base plate is made of concrete and manufactured by means of industrial methods at a factory. A collection vessel to collect any leaking transformer oil is also included in the base plate. The base plate is arranged to be transported, in finished condition, to the construction site and to be erected there directly on the ground which has been prepared in advance.

The first switchgear module 2 is placed next to the base module. This switchgear module accommodates a withdrawable circuit breaker 10, cable terminations 11, surge arresters 12, disconnecting switches 13, and a neutral-point reactor 15. The module is constructed as a container with a floor 17, side walls 16 and a roof 18 secured to each other and with end pieces 19 containing door portions. The module also comprises partitions 14 which in the example shown comprise portions with protective grating and portions with Plexiglass.

On the side opposite to the base module, the substation comprises a second switchgear module 2. This module includes a cubicle-type switchgear unit 21 for 11 kV. Further, the module includes a ventilation device 20, an ac distribution board 22, a dc box 23, a battery 24, and a relay box 25. Also this module comprises a construction similar to that of a container. Side walls 26, floor 27 and roof 28 are joined together to form a stable building structure. In an advantageous embodiment, the walls comprise a double construction with an inner and an outer layer of steel sheet and an intermediate layer of mineral wool. In a further advantageous embodiment, the inner layer comprises a perforated steel sheet, wherein this steel sheet together with the mineral wool forms a sound absorber.

The switchgear modules with their respective contents are manufactured industrially at a factory and are transported in finished condition to the site of erection. While the manufacture of the switchgear modules is in progress, preparation of the ground is carried out at the site in order to receive the modules. Thus, the ground surface is stabilized, provided with capillarity breaking layers, and smoothed. Cables for supply to and from the station have been buried in the ground in advance, with their connections arranged close to the location of the base module. In a first embodiment, the switchgear modules are arranged adjacent to the base module so that the switchgear modules form walls for the base module. In a second embodiment, the switchgear modules are arranged suspended from the base module. To this end, points of attachment are arranged on the frame structure for suspending the switchgear modules. By suspending the switchgear modules from the base module, the requirement for ground preparation is reduced. The suspension means that only that ground portion that lies below the module needs to be prepared. In a further embodiment, the gap, if any, that is formed between the underside of the switchgear modules and the ground is surrounded by a fence. Such a fence is particularly advantageous if there is a risk that animals may come into contact with cables and other equipment that penetrate the floors.

Preferably medium voltage comprises the voltage range between 6 kV and 52 kV. In one embodiment, the substation comprises a first connection side for 10-52 kV and a second connection side for 6-20 kV. A complete station thus comprises a base module, a transformer, a frame structure, a roof module, as well as a first switchgear module and a second switchgear module. Power cables for connection between the transformer and the first switchgear module are also prefabricated with connections and are stored during the transport on the roof of the switchgear module. Control cables are mounted and connected at the factory and accompany the switchgear module during the transport. By prefabricating and connecting the cables in this way, the functions of all the modules may be tested prior to transport. Advantageously, ground cables are connected to the undersides of the modules whereas connections between the modules are carried out via the roofs. The ends of the cabling are provided with an interface that makes it possible to rapidly connect the modules to each other at the construction site. A protective roof is built over the switchgear modules and is connected to the base module. The roof of the base module is carried out as a self-supporting module that may be removed, for example to enable the transformer to be lifted out and replaced by a new one.

In a further development, the first switchgear module, in the case of a 52-kV embodiment, is provided with a neutral-point connection and the door to the circuit breaker arranged with double gates to allow evacuation if an arc should arise.

1. A transformer substation, comprising:
a transformer,
a first enclosed switchgear module comprising a side wall and switching equipment,
a second enclosed switchgear module comprising a side wall and switchgear equipment, and
a base module for receiving the transformer, the base module comprising a roof module, wherein the side wall of the first switchgear module and the side wall of the second switchgear module form walls of the base module.

2. The substation according to claim 1, wherein the first switchgear module and the second switchgear module are suspended on the base module.

3. The substation according to claim 1, wherein the base module comprises a base plate for receiving the transformer and wherein the base module comprises a collection vessel for transformer oil reception.

4. The A substation according to claim 1, wherein the first switchgear module comprises a neutral-point reactor.

5. The substation according to claim 1, wherein the second switchgear module comprises a ventilation device.

6. The substation according to claim 1, further comprising:
a mobile platform.

7. A method for providing a substation comprising a transformer, a first enclosed switchgear module comprising a side wall and containing switching equipment, and a second enclosed switchgear module comprising a side wall and containing switchgear equipment, the method comprising:
industrially manufacturing a base module for receiving the transformer, the first switchgear module including the switching equipment and the second switchgear module including the switchgear equipment,
transporting the modules to the site of erection, and
assembling the side wall of the first enclosed switchgear module to and the side wall of the second enclosed switchgear module to form walls of the base module.

8. The method according to claim 6, wherein the assembling comprises suspension of the first switchgear module and the second switchgear module on the base module.

9. Use of a substation according to claim 1 as a mobile bypass connection of an existing substation.

10. Use of a method according to claim 7 as a mobile bypass connection of an existing substation.
